(19) United States
(12) Patent Application Publication
(10) Pub. No.: US 2002/0169599 A1
(43) Pub. Date: Nov. 14, 2002

(54) Digital audio compression and expansion circuit

(76) Inventor: Toshihiko Suzuki, Hamamatsu-shi (JP)

Correspondence Address: Pillsbury Winthrop LLP, Intellectual Property Group, Suite 2800, 725 South Figueroa Street, Los Angeles, CA, 90017-5406, US

(21) Appl. No.: 10/141,639

(22) Filed: May 7, 2002

(30) Foreign Application Priority Data
May 11, 2001 (JP) P2001-141974

(51) Int. Cl. G10L 19/00

(52) U.S. Cl. 704/200.1

(57) ABSTRACT

Digital audio data of one phrase are divided into frames, wherein each frame is divided into thirty-six sub-frames and is further divided into sub-band data of thirty-two sub-bands. The digital audio data are compressed in accordance with the MPEG/Audio Layer 2 in such a way that each sub-band data are subjected to psychoacoustics analysis, whereas ‘A’ samples must occur to provide a non-sound duration in the head portion of the compressed data. The non-sound duration is adjusted in time length to just match one frame, so that bit streams are generated based on the compressed data whose first frame is deleted. In the expansion, bit streams are decoded to reproduce sub-band data, which are combined together based on ancillary data, representing the number of valid samples contained in the last frame, in such a way that another non-sound duration is deleted from the last frame of the compressed data.

### BACKGROUND OF THE INVENTION

1. Field of the Invention

This invention relates to digital audio compression and expansion circuits, in particular, for the MPEG/Audio Layer 2 standard (where ‘MPEG’ stands for ‘Motion Picture Experts Group’).

2. Description of the Related Art

Recently, various types of MPEG/Audio standards have been developed, so that various types of technologies for compression and expansion of digital audio data have been developed and widely used in various fields such as broadcasting and audio devices.

Broadcasting apparatuses and CD players may seldom perform repetitive playback of the same software. In contrast, game devices may frequently perform repetitive playback of short sounds having a prescribed effect. For this reason, it is required that game devices provide repetitive playback functions to ensure compression and expansion techniques based on the MPEG/Audio standard.

In the conventional MPEG/Audio standard, however, non-sound duration must occur before and after the compressed data. Therefore, in the repetitive playback, the sound must be intermittently or suddenly cut off due to the existence of the non-sound duration. FIG. 4A shows one phrase of digital audio data that have been subjected to pulse-code modulation (PCM) but have not been subjected to compression yet. FIG. 4B shows compressed data that are produced by compressing the digital audio data (or PCM audio data) in accordance with the MPEG/Audio standard. Herein, one phrase of the compressed data is preceded by a non-sound duration, which contains a certain number of samples (e.g., two-hundred samples plus several tens of samples; hereinafter, simply referred to as ‘A’ samples). In addition, it is followed by another non-sound duration, which is based on ‘invalid’ samples of the last frame excluding ‘valid’ samples.

### SUMMARY OF THE INVENTION

It is an object of the invention to provide a digital audio compression and expansion circuit that is capable of performing repetitive playback without causing intermittent and sudden breaks in the sound when playing back digital audio data based on the MPEG/Audio Layer2 standard, for example.

In the digital audio compression circuit of this invention, digital audio data (e.g., pulse-code modulated (PCM) data) of one phrase are divided into frames. Each frame consists of 1152 samples and is divided into thirty-six sub-frames, each of which is further divided into sub-band data with respect to thirty-two sub-bands respectively. The digital audio data are compressed in such a way that each sub-band data is subjected to psychoacoustics analysis. The compressed data are added with the prescribed control information, which provide ancillary data representing the number of valid samples contained in the last frame. Due to the compression based on the MPEG/Audio Layer2 standard, a certain number of samples (simply referred to as ‘A’ samples, which are two-hundred samples plus several tens of samples) must occur in the head portion of the compressed data of one phrase. The data compression circuit automatically adds the prescribed number of samples to ‘A’ samples, thus adjusting the non-sound duration in time length to match just one frame in the head portion of the compressed data. Bit streams are generated based on the compressed data in such a way that the first frame is deleted from the compressed data, to which the ancillary data are added.

In the data expansion circuit of this invention, bit streams are decoded to reproduce sub-band data, which are combined together based on the ancillary data in such a way that another non-sound duration, which occurs in the last frame of the compressed data, is deleted.

Thus, it is possible to reliably avoid occurrence of intermittent and sudden breaks in the sound during the repetitive playback.

### BRIEF DESCRIPTION OF THE DRAWINGS

These and other objects, aspects, and embodiments of the present invention will be described in more detail with reference to the following drawing figures, in which:

FIG. 1 is a block diagram showing the configuration of a data compression circuit in accordance with a preferred embodiment of the invention;

FIG. 2A shows one phrase of PCM audio data prior to compression;

FIG. 2B shows one phrase of compressed data;

FIG. 2C shows one phrase of expanded PCM audio data;

FIG. 3 is a block diagram showing the configuration of a data expansion circuit in accordance with the preferred embodiment of the invention;

FIG. 4 is a block diagram showing the configuration of a data expansion circuit, which is a modified example of the data expansion circuit shown in FIG. 3;

FIG. 5A simply shows one phrase of PCM audio data prior to compression in accordance with the MPEG/Audio standard; and

FIG. 5B simply shows one phrase of compressed data that are preceded and followed by non-sound duration.

### DESCRIPTION OF THE PREFERRED EMBODIMENTS

This invention will be described in further detail by way of examples with reference to the accompanying drawings.

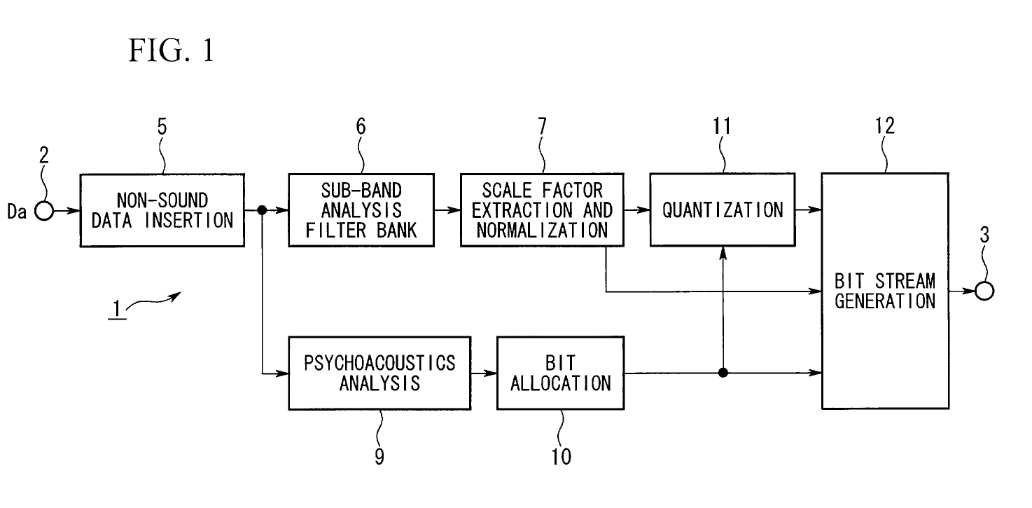

FIG. 1 is a block diagram showing the configuration of a data compression circuit 1 in accordance with a preferred embodiment of the invention. In the data compression circuit 1 of FIG. 1, digital audio data Da that have been subjected to pulse-code modulation (PCM) are input to an input terminal 2 and are then compressed in accordance with the MPEG/Audio Layer2 standard, so that compressed data consisting of bit streams are output from an output terminal 3. Incidentally, the MPEG/Audio Layer2 may contain both the MPEG1/Audio Layer2 and MPEG2/Audio Layer2.

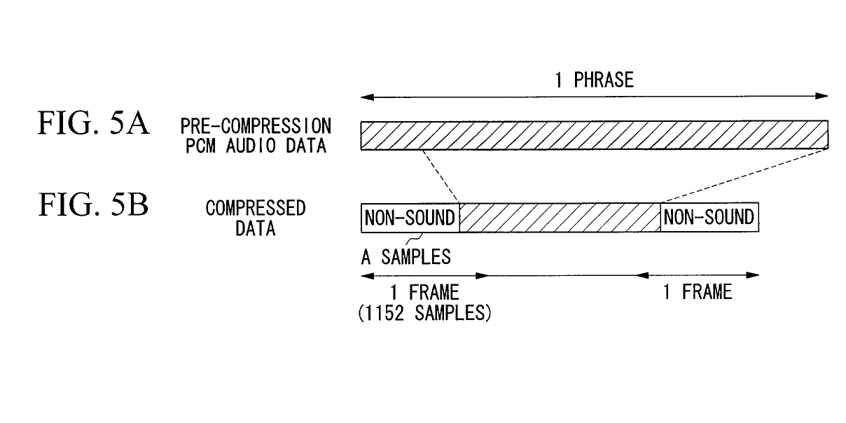

The data compression circuit 1 contains a non-sound data insertion section 5, which is followed by various sections 6, 7, 9, 10, 11, and 12 constituting a data compression section. That is, the data compression section performs the prescribed data compression in accordance with the MPEG/Audio Layer2, so that a non-sound duration of A samples occur to precede one phrase of compressed data, which was described with reference to FIGS. 5A and 5B.

The non-sound duration occurs at the head portion of the phrase because of the specific property of the MPEG/Audio Layer2 standard in which data compression is performed by FIR filter calculations normally with respect to 512 taps. That is, in the prescribed time period corresponding to two-hundred samples and several tens of samples in the head portion of the phrase that may precede the actual timing when sample data values are input with respect to the center tap(s) that may use relatively large filter coefficients, the FIR filter calculations may produce the considerably small number of calculation results. Therefore, in this time period in which calculation results are considerably reduced, substantially no sound will be reproduced. Another non-sound duration may occur in the last frame because of the following reasons:

(1) The end of the digital audio data may not completely match the breakpoint of the frame.

(2) In the MPEG/Audio Layer2 standard, data compression is performed by FIR filter calculations with respect to 512 taps, so that calculation results are considerably reduced with respect to the center tap(s) and the like.

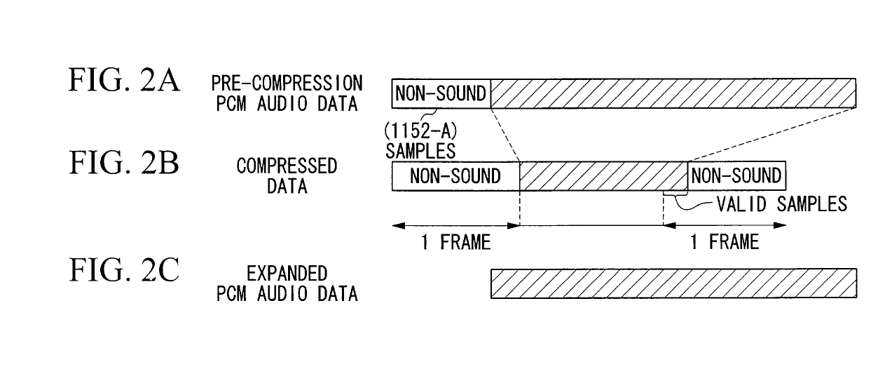

Because of the aforementioned reasons, the non-sound data insertion section 5 inserts in advance a non-sound duration of (1152-A) samples at the head portion of the PCM audio data Da input to the input terminal 2. Thus, the non-sound data insertion section 5 outputs ‘pre-compression’ PCM audio data whose head portion corresponds to the non-sound duration shown in FIG. 2A. Due to the processing of the non-sound data insertion section 5, the non-sound duration corresponding to the head portion of the compressed data of one phrase will just match one frame after completion of compression. Reasons will be described later. In the above, the number ‘1152’ represents the number of samples contained in one frame in accordance with the MPEG/Audio Layer2 standard.

The PCM audio data output from the non-sound data insertion section 5 are divided into blocks each containing the prescribed number of samples. These blocks of the PCM audio data are subjected to processing by way of two paths. In the first path, a sub-band analysis filter bank 6 divides the PCM audio data into sub-band data of thirty-two bands, each having the same bandwidth, with respect to each sub-frame that contains thirty two samples. Specifically, one frame of the PCM audio data is divided into thirty-six sub-frames, each of which is further divided into sub-band data of thirty-two bands. In this case, each sub-band data is down-sampled by 1/32 of the sampling frequency. A scale factor extraction and normalization circuit 7 detects a sample (or samples) having a maximal absolute value with respect to each of the subband data contained in one frame. This value is subjected to logarithmic conversion and quantization to produce a scale factor. Each sub-band sample is divided by the scale factor to be normalized within the range of ±1.

In the second path, a psychoacoustics analysis section 9 performs frequency spectrum calculations using the fast Fourier transform (FFT), thus producing a masking threshold, i.e., an allowable quantization noise power with respect to each sub-band. A bit allocation section 10 performs repetitive loop processing on the output of the psychoacoustics analysis section 9 under the prescribed restriction regarding the number of bits that can be used for one frame, thus determining the number of bits in quantization with respect to each sub-band.

In a quantization section 11, the sub-band data output from the scale factor extraction and normalization circuit 7 are subjected to quantization in response to the number of bits in quantization that is set with respect to each sub-band. Then, the quantized output of the quantization section 11 is supplied to a bit stream generation section 12.

The bit stream generation section 12 deletes first one frame consisting of 1152 samples from sub-band samples of one phrase that was quantized. FIG. 2A shows pre-compression PCM audio data that are output from the non-sound data insertion section 5; and FIG. 2B shows compressed data. Herein, the head portion of the compression data corresponds to non-sound data of one frame consisting of 1152 samples, which are deleted by the aforementioned process of the bit stream generation section 12. Then, the bit stream generation section 12 multiplexes bit allocation information and a scale factor with respect to each sub-band, which is then added with a header to generate a bit stream. At this time, it detects the number of valid samples in the last frame (see FIG. 2B), which is written into the bit stream as ancillary data for the last frame. Thus, the bit stream generation section 12 outputs the bit stream to the output terminal 3.

FIG. 2B is an image of compressed data in which the non-sound duration is magnified, whereas the actual number of bits corresponding to the non-sound duration is considerably reduced by compression.

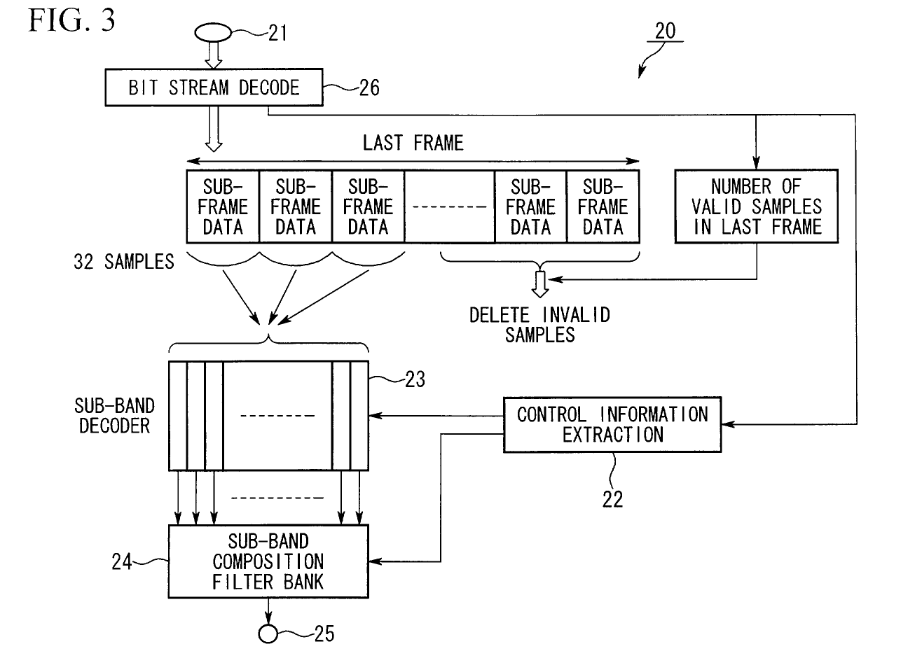

Next, a data expansion circuit that expands the digital audio data compressed by the aforementioned data compression circuit 1 will be described with reference to FIG. 3. In a data expansion circuit 20 shown in FIG. 3, compressed data consisting of bit streams are input to an input terminal 21 and are then supplied to a bit stream decode circuit 26. The bit stream decode circuit 26 isolates bit allocation information and scale factors from the bit streams input thereto, and outputs them to a control information extraction circuit 22. In addition, the bit stream decode circuit 26 sequentially outputs sub-frame data each consisting of thirty-two samples to a subband decoder 23. With respect to the last frame of one phrase, sub-frame data are supplied to the sub-band decoder 23 up to the prescribed sub-frame that is defined by the number of valid samples contained in the ancillary data, whereas other sub-frame data (composed of invalid samples) are not supplied to the sub-band decoder 23.

The control information extraction circuit 22 supplies the bit allocation information and scale factors to the sub-band decoder 23. The sub-band decoder 23 decodes the compressed data into sub-band data of thirty-two sub-bands with respect to each sub-frame. That is, the sub-band decoder 23 performs inverse quantization on each sub-band data, which are then multiplied by the scale factor in decoding. Thus, the sub-band decoder 23 provides ‘decoded’ thirty-two sub-band data to a sub-band composition filter bank 24. The sub-band composition filter bank 24 combines together the thirty-two sub-band data, output from the sub-band decoder 23, to reproduce PCM audio data, which are then output to an output terminal 25.

According to the present embodiment described above, the bit stream generation section 12 of the data compression circuit 1 deletes the non-sound duration corresponding to the head portion of the PCM audio data; then, the bit stream decode circuit 26 of the data expansion circuit 20 deletes the non-sound duration contained in the last frame. Thus, the data expansion circuit 20 outputs the PCM audio data that do not contain the non-sound duration as shown in FIG. 2C. As a result, it is possible to reliably avoid occurrence of intermittent or sudden breaks of the sound due to the existence of the non-sound duration even when the expanded PCM audio data are repeatedly played back.

The present embodiment is designed in such a way that the bit stream decode circuit 26 extracts the number of valid samples contained in the last frame. Alternatively, the control information extraction circuit 22 extracts the number of valid samples, according to which the sub-frames input to the sub-band decoder 23 can be controlled.

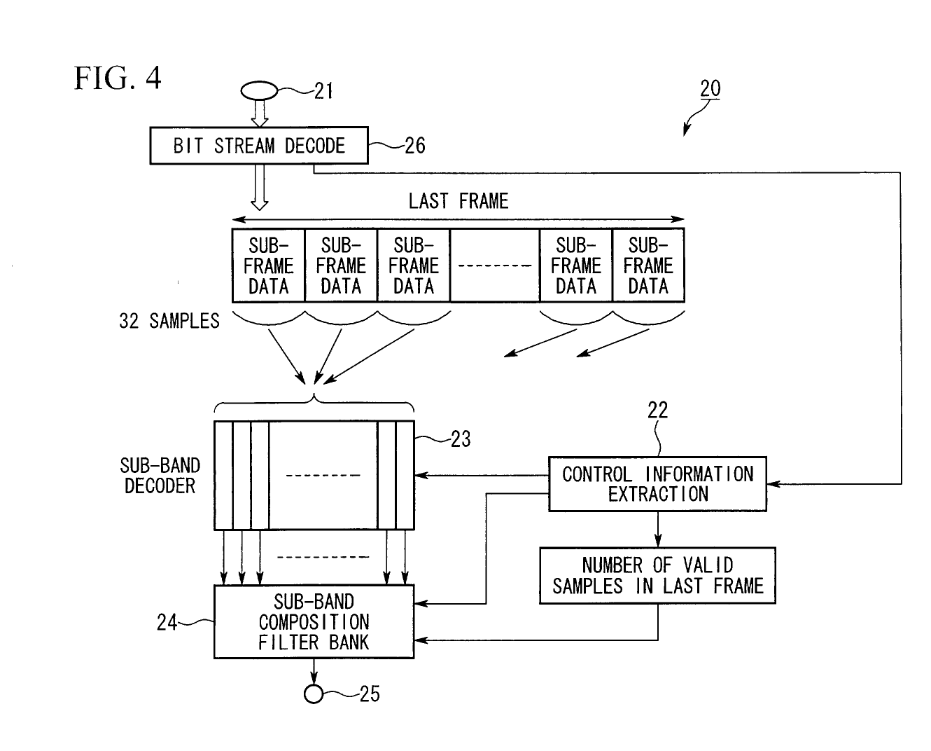

It is possible to provide a data expansion circuit shown in FIG. 4, which is created by partially modifying the data expansion circuit of FIG. 3. That is, the control information extraction circuit 22 extracts the number of valid samples contained in the last frame, which is then provided to the sub-band composition filter bank 24. In this case, the sub-band composition filter bank 23 performs sub-band composition on the last frame in the prescribed range from its first sub-frame data to certain sub-frame data that contain the valid samples, the number of which is extracted and designated by the control information extraction circuit 22. Thus, the sub-band composition filter bank 24 reproduces the PCM audio data without using other subband data contained in the last frame. As a result, the data expansion circuit 20 of FIG. 4 deletes the non-sound duration, which is contained in the last frame of one phrase (see FIG. 2B), by the unit of thirty-two samples.

It is possible to further modify the data compression circuit 1 of FIG. 1 in such a way that the bit stream generation section 12 automatically and completely deletes the last frame of one phrase (see FIG. 2B). In this case, a part of the original PCM audio data should be deleted; however, the processing can be simplified.

The present embodiment is designed under the precondition that the number of valid samples is written into the ancillary data of the last frame of the bit stream. Instead, the number of valid samples can be provided as specific data independently of the bit stream, so that the specific data are directly supplied to the sub-band composition filter bank 24.

Incidentally, all functions of the data compression and expansion circuits of this invention can be easily implemented by computer programs that are stored in digital storage media and the like and are executed by computers.

As described heretofore, this invention can completely eliminate the nonsound duration from the expanded PCM audio data. Hence, it is possible to reliably avoid occurrence of intermittent and sudden breaks in the sound even when the expanded data are repeatedly played back. In addition, this invention can completely exclude the non-sound duration from the head portion of the expanded data. Therefore, it is possible to considerably reduce the ‘unwanted’ delay time for the actual playback of the sound after the issuance of a playback instruction.

As this invention may be embodied in several forms without departing from the spirit or essential characteristics thereof, the present embodiments are therefore illustrative and not restrictive, since the scope of the invention is defined by the appended claims rather than by the description preceding them, and all changes that fall within metes and bounds of the claims, or equivalents of such metes and bounds are therefore intended to be embraced by the claims.

What is claimed is:

1. A digital audio compression circuit in which digital audio data are divided into a plurality of frames, each consisting of a prescribed number of samples, each of which is further divided into a plurality of sub-band data with respect to sub-bands respectively so that the plurality of sub-band data are each compressed by psychoacoustics analysis to cause a first number of samples for reproducing no sound in a first frame, said digital audio compression circuit comprising:
a non-sound duration provider for providing a non-sound duration of one frame at a head portion of the compressed digital audio data by automatically adding a second number of samples for reproducing no sound to the first number of samples that originally occur in the head portion of the compressed digital audio data to reproduce no sound; and
a non-sound duration deletion for deleting the non-sound duration of one frame from the head portion of the compressed digital audio data.

2. A digital audio compression circuit according to claim 1, wherein the plurality of sub-band data are each compressed by psychoacoustics analysis to cause a first number of samples for reproducing no sound in a first frame while causing a third number of samples for reproducing no sound in a last frame, said digital audio compression circuit further comprising
a detector for detecting a number of valid samples contained in the last frame of the compressed digital audio data by subtracting the third number of samples from the prescribed number of samples constructing each frame.

3. A digital audio compression circuit according to claim 2, wherein the plurality of sub-band data are respectively compressed and combined together to form a bit stream, which is added with ancillary data representing the number of valid samples contained in the last frame.

4. A digital audio compression circuit according to claim 1, wherein the plurality of sub-band data are each compressed by psychoacoustics analysis to cause a first number of samples for reproducing no sound in a first frame while causing a third number of samples for reproducing no sound in a last frame, said digital audio compression circuit further comprising
a secondary deletion for deleting the last frame from the compressed digital audio data.

5. A digital audio compression circuit wherein digital audio data are divided into a plurality of frames, each consisting of a prescribed number of samples, each of which is further divided into a plurality of sub-band data with respect to sub-bands respectively so that the plurality of sub-band data are each compressed by psychoacoustics analysis to cause a number of samples for reproducing no sound in a last frame, said digital audio compression circuit comprising:
a deletion for deleting the last frame of the compressed digital audio data.

6. A digital audio compression circuit wherein digital audio data are divided into a plurality of frames, each consisting of a prescribed number of samples, each of which is further divided into a plurality of sub-band data with respect to sub-bands respectively so that the plurality of sub-band data are each compressed by psychoacoustics analysis to cause a number of invalid samples for reproducing no sound in a last frame, said digital audio compression circuit comprising:
a detection for detecting a number of valid samples by subtracting the number of in valid samples for reproducing no sound from the prescribed number of samples constructing each frame; and
an addition for adding ancillary data representing the detected number of valid samples contained in the last frame to the compressed digital audio data.

7. A digital audio expansion circuit comprising:
a compressed digital audio data provider for providing compressed digital audio data, which are compressed with respect to frames respectively and are added with ancillary data representing a number of valid samples contained in a specific frame;
a sub-band decoder for decoding the compressed digital audio data with respect to the frames respectively except for the specific frame, thus reproducing sub-band data with respect to sub-bands respectively, wherein the valid samples contained in the specific frame are also decoded to sub-band data; and
a sub-band composition for combining together all the sub-band data containing the sub-band data corresponding to the valid samples contained in the specific frame, thus reproducing the digital audio data.

8. A digital audio expansion circuit according to claim 7, wherein the specific frame is a last frame of the compressed digital audio data.

9. A digital audio compression method applied to digital audio data that are divided into a plurality of frames, each consisting of a prescribed number of samples, each of which is further divided into a plurality of sub-band data with respect to sub-bands respectively, wherein the plurality of sub-band data are each compressed by psychoacoustics analysis to cause a first number of samples for reproducing no sound in a first frame, said digital audio compression method comprising the steps of:
providing a non-sound duration of one frame at a head portion of the compressed digital audio data by automatically adding a second number of samples for reproducing no sound to the first number of samples that originally occur in the head portion of the compressed digital audio data to reproduce no sound; and
deleting the non-sound duration of one frame from the head portion of the compressed digital audio data.

10. A digital audio compression method applied to digital audio data that are divided into a plurality of frames, each consisting of a prescribed number of samples, each of which is further divided into a plurality of sub-band data with respect to sub-bands respectively, wherein the plurality of sub-band data are each compressed by psychoacoustics analysis to cause a number of samples for reproducing no sound in a last frame, said digital audio compression method comprising the step of:
deleting the last frame from the compressed digital audio data.

11. A digital audio compression method applied to digital audio data that are divided into a plurality of frames, each consisting of a prescribed number of samples, each of which is further divided into a plurality of sub-band data with respect to sub-bands respectively, wherein the plurality of sub-band data are each compressed by psychoacoustics analysis to cause a number of invalid samples for reproducing no sound in a last frame, said digital audio compression method comprising the steps of:
detecting a number of valid samples from the last frame by subtracting the number of invalid samples for reproducing no sound from the prescribed number of samples constructing each frame; and
adding ancillary data representing the detected number of valid samples contained in the last frame to the compressed digital audio data.

12. A digital audio expansion method comprising the steps of:
providing compressed digital audio data, which are compressed with respect to frames respectively and are added with ancillary data representing a number of valid samples contained in a specific frame;
decoding the compressed digital audio data with respect to the frames respectively except for the specific frame, thus reproducing sub-band data with respect to sub-bands respectively, wherein the valid samples contained in the specific frame are also decoded to sub-band data; and
combining together all the sub-band data containing the sub-band data corresponding to the valid samples contained in the specific frame, thus reproducing the digital audio data.

13. A computer program implementing a digital audio compression method applied to digital audio data that are divided into a plurality of frames, each consisting of a prescribed number of samples, each of which is further divided into a plurality of sub-band data with respect to sub-bands respectively, wherein the plurality of sub-band data are each compressed by psychoacoustics analysis to cause a first number of samples for reproducing no sound in a first frame, said digital audio compression method comprising the steps of:
providing a non-sound duration of one frame at a head portion of the compressed digital audio data by automatically adding a second number of samples for reproducing no sound to the first number of samples that originally occur in the head portion of the compressed digital audio data to reproduce no sound; and
deleting the non-sound duration of one frame from the head portion of the compressed digital audio data.

14. A computer program implementing a digital audio compression method applied to digital audio data that are divided into a plurality of frames, each consisting of a prescribed number of samples, each of which is further divided into a plurality of sub-band data with respect to sub-bands respectively, wherein the plurality of sub-band data are each compressed by psychoacoustics analysis to cause a number of samples for reproducing no sound in a last frame, said digital audio compression method comprising the step of:
deleting the last frame from the compressed digital audio data.

15. A computer program implementing a digital audio compression method applied to digital audio data that are divided into a plurality of frames, each consisting of a prescribed number of samples, each of which is further divided into a plurality of sub-band data with respect to sub-bands respectively, wherein the plurality of sub-band data are each compressed by psychoacoustics analysis to cause a number of invalid samples for reproducing no sound in a last frame, said digital audio compression method comprising the steps of:
detecting a number of valid samples from the last frame by subtracting the number of invalid samples for reproducing no sound from the prescribed number of samples constructing each frame; and
adding ancillary data representing the detected number of valid samples contained in the last frame to the compressed digital audio data.

16. A computer program implementing a digital audio expansion method comprising the steps of:
providing compressed digital audio data, which are compressed with respect to frames respectively and are added with ancillary data representing a number of valid samples contained in a specific frame;
decoding the compressed digital audio data with respect to the frames respectively except for the specific frame, thus reproducing sub-band data with respect to sub-bands respectively, wherein the valid samples contained in the specific frame are also decoded to sub-band data; and
combining together all the sub-band data containing the sub-band data corresponding to the valid samples contained in the specific frame, thus reproducing the digital audio data.
